(19) United States
(12) Patent Application Publication
(10) Pub. No.: US 2002/0052972 A1
(43) Pub. Date: May 2, 2002

(54) Communication method among a plurality of virtual LANs in an IP subnet

(75) Inventor: Ui-Suk Yim, Incheon (KR)

Correspondence Address: FLESHNER & KIM, LLP, P.O. Box 221200, Chantilly, VA, 20153-1200, US

(73) Assignee: LG Electronics, Inc.

(21) Appl. No.: 09/939,558

(22) Filed: Aug. 28, 2001

(30) Foreign Application Priority Data
Aug. 29, 2000 (KR) 50477/2000

(51) Int. Cl. G06F 15/16; H04L 12/28

(52) U.S. Cl. 709/245; 370/254

(57) ABSTRACT

Disclosed is a local area network (LAN) and, more particularly, a communication method among a plurality of virtual LANs in an identical Internet protocol (IP) subnet. If a switching router receives a broadcast packet from a source host, it transmits the broadcast packet to all the virtual LANs to which the source host is included as well as to another virtual LAN to which a destination host is included, and thus a broadcast domain can be formed through the virtual LANs on the identical IP subnet. Also, the source host and the destination host included in the different virtual LANs transmit unicast packets to the switching router, respectively, and the switching router relays the unicast packets to the corresponding hosts, thereby enabling the communication among the virtual LANs included in the identical IP subnet.

### BACKGROUND OF THE INVENTION

1. Field of the Invention

The present invention relates generally to a local area network (LAN) and, more particularly, to a communication method among a plurality of virtual LANs in an Internet protocol (IP) subnet.

2. Background of the Related Art

Generally, a LAN is a communication network wherein computers in the same building, such as a company, school, etc., or located at the same site, are connected together to communicate with one another. An ethernet has been generally used for a small scale LAN.

FIG. 1 shows the basic structure of a packet (i.e., frame) that is a transmission unit of the ethernet. A destination address (DA) represents a media access control (MAC) address that is a physical address of a host, which is to receive the packet. A source address (SA) represents a MAC address that is a physical address of a host that is to transmit the packet. A type represents a kind of packet and the user data represents data that the host intends to transmit. Together these fields comprise an IP packet generated in an IP module. A source host connected to the ethernet performs communication with the destination host by inserting the MAC address of the destination host that is to receive the data in the DA field and inserting its own MAC address in the SA field.

The ethernet discriminates nodes using the MAC address and receives only the packets having a MAC destination address matching the physical address of a host directly connected to the ethernet. If the MAC address included in the DA field is a broadcast address (for instance, an address having all of the values of the DA field set to “1”), then all of the hosts receive the packet.

The operation of an ethernet switch for switching the packets transmitted/received among the hosts in the ethernet will be explained with reference to FIG. 2. To determine the MAC destination address of the tenth host 3, the first host 1 generates an address resolution protocol (ARP) request (ARP_REQUEST) packet as shown in FIG. 3A. First host 1 inserts a broadcast MAC address in the DA field and transmits the ARP_REQUEST packet to the ethernet switch 2. The IP packet field of the ARP_REQUEST packet, shown in FIG. 3A, includes a destination IP address (DI) field representing the IP address of the destination host and a source IP address (SI) field representing the IP address of the source host.

The ethernet switch 2 checks the received ARP_REQUEST packet and, if the packet is the broadcast packet or a packet that is not registered in a MAC table, it transmits the received ARP_REQUEST packet through all ports. Then, the ethernet switch 2 registers the MAC address of the first host 1 in its MAC table, using the information contained in the SA field of the received ARP_REQUEST packet.

All of the hosts connected to the ethernet switch 2 receive the ARP_REQUEST packet, check the DI field of the received ARP_REQUEST packet, and judge whether they are the intended recipient of the ARP_REQUEST packet. The tenth host 3 responds to the ARP_REQUEST packet, if the DI field of the received ARP_REQUEST packet contains the destination IP address identifying the tenth host 3.

In response to the ARP_REQUEST packet sent by the first host 1, the tenth host 3 attaches the MAC address of the first host in the DA field and its own MAC address in the SA field of an ARP_RESPONSE packet, which is illustrated in FIG. 3B. Then, the tenth host 3 transmits the generated ARP_RESPONSE packet to the ethernet switch 2.

The ethernet switch 2 searches the MAC table using the DA field value of the received ARP_RESPONSE packet. The ethernet switch 2 determines which port is intended to receive the ARP_RESPONSE packet and transmits the ARP_RESPONSE packet to this port. Also, the ethernet switch 2 registers in the MAC table that the tenth host 3 is connected to the tenth port, using the information of the ARP_RESPONSE packet.

The first host 1 receives the ARP_RESPONSE packet from the ethernet switch 2, detects the MAC address of the tenth host 3, and then transmits a unicast packet, as shown in FIG. 3C, to the tenth host 3. As a result, the first host and the tenth host 3 may communicate with each other.

Many broadcasting packets, such as the ARP packets described above, may be communicated in the LAN environment. However, the traffic of the many broadcast packets is a primary factor causing the deterioration of the network's performance. To ameliorate this situation some, a virtual LAN (VLAN) has been produced.

Specifically, the VLAN is a network whose broadcast domain is compulsorily defined, irrespective of the physical network configuration. Thus, the broadcast packet is broadcast only in the corresponding VLAN, thereby reducing the traffic of the network due to the restricted domain of the broadcast packets.

Numerous types of VLANs exist, including a port-based VLAN, a MAC-based VLAN, a protocol-based VLAN, and an IP-based VLAN. Recently, the port-based VLAN has become the most commonly used type and is the type described hereinafter.

A switching router connected among the port-based VLANs transmits a received broadcast packet or received unknown packet to the hosts within the same IP subnet as the packet sourcing host. All of the hosts within a subnet share a single VLAN port. Broadcast or unknown packet messages are never communicated between VLAN ports by the router. After the router retransmits the received message back into the VLAN from which it originated, it adds a number field of the VLAN in the MAC table.

FIG. 4 shows the configuration of VLANs 10, 30 forming different IP subnets and a switching router 20 interconnecting the IP subnets. In an attempt to communicate with the tenth host 31, within the second VLAN 30, the first host 11 of the first VLAN 10 transmits a broadcast ARP_REQUEST packet to the switching router 20. Since communication between the different VLANs may occur only through the switching router 20, the VLANs necessarily belong to different IP subnets. Switching router 20 rebroadcasts the received ARP_REQUEST packet only to the first VLAN 10 from which the packet came. The ARP_REQUEST packet is not forwarded by the router 20 to port eight for rebroadcast within the second VLAN 30. Therefore, the destination host 31 within the second VLAN 30 cannot receive the ARP_REQUEST packet. Since the broadcast domain of the VLAN is compulsorily defined, one IP subnet corresponds to one VLAN.

As a result, the conventional VLAN has the problem that a plurality of VLANs cannot be configured in the same IP subnet. Thus, a plurality of IP subnets are configured, even in the small-scale LAN, where a plurality of IP subnets are not otherwise required.

### SUMMARY OF THE INVENTION

An object of the invention is to solve at least the above problems and/or disadvantages and to provide at least the advantages described hereinafter.

Therefore, an object of the invention is to solve the problems involved in the related art and to provide a communication method among a plurality of VLANs in the same IP subnet.

In accordance with the present invention, this objects accomplished by providing a communication method among a plurality of VLANs in an identical IP subnet, comprising the steps of configuring the plurality of VLANs in the identical IP subnet; broadcasting a first ARP request packet transmitted from a source host to a VLAN where the source host is included; transmitting a first ARP response packet for responding to the first ARP request packet to the source host, and broadcasting a second ARP request packet to a VLAN where a destination host of the first ARP request packet is included; and receiving a second ARP response packet from the destination host, and transmitting a unicast packet transmitted from the source host to the destination host using a MAC address of the destination host that is included in the received second ARP response packet.

In another aspect of the present invention, there is provided a broadcast domain determining method for communications among a plurality of VLANs in an identical IP subnet, the method comprising the steps of judging a VLAN which is included in the identical IP subnet which includes the VLAN to which the source host belongs, if an ARP request packet is received from a source host; judging all ports connected to the judged VLAN; broadcasting the ARP request packet to all the judged ports; searching a port to which a destination host of the ARP request packet is included; and broadcasting the ARP-request packet to the VLAN connected to the searched port.

In still another aspect of the present invention, there is provided a communication method among a plurality of VLANs in an identical IP subnet, comprising the steps of broadcasting an ARP request packet to communicate with a destination host that belongs to the identical IP subnet but belongs to a different VLAN from the source host; informing the source host of a MAC address of a switching router by the switching router in response to the ARP request; obtaining a MAC address of the destination host by broadcasting the ARP request to the VLAN in which the destination host is included from the switching router; transmitting a data packet to be transmitted to the destination host from the source host to the switching router; and transmitting the received data packet from the switching router to the destination host using the MAC address of the destination host.

The objects of the present invention may be achieved in whole or in part by a communication method among a plurality of networks in the same subnet, including associating a destination proxy address with a first intermediate address and a destination address, communicating a first message from a source host, within a first network of the plurality of networks, to a destination host, within a second network of the plurality of networks, by addressing the first message to the first intermediate address of an intermediary device, which supports communication among the plurality of networks, replacing the first intermediate address accompanying the first message with the associated destination address of the destination host, and communicating the first message from the intermediate device to the destination host by addressing the first message to the destination address.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The preferred embodiments of the invention will be described in detail with reference to the following drawings in which like reference numerals refer to like elements wherein:

FIG. 1 illustrates the basic structure of a frame that is a transmission unit of an ethernet;

FIG. 2 illustrates the connection among hosts and an ethernet switch in the related art ethernet;

FIG. 3A illustrates the structure of an ARP request packet transmitted from the source host to the ethernet switch of FIG. 2;

FIG. 3B illustrates the structure of an ARP response packet transmitted from the destination host and later retransmitted by the ethernet switch to the source host of FIG. 2;

FIG. 3C illustrates the structure of a unicast packet transmitted from the source host to the destination host;

FIG. 4 illustrates the configuration of the related art communication apparatus among a plurality of VLANs in different IP subnets;

FIG. 5 illustrates the configuration of a communication apparatus among a plurality of VLANs in the same IP subnet according to a preferred embodiment of the present invention;

FIG. 6A illustrates the structure of an ARP request packet transmitted from a source host to a switching router of FIG. 5;

FIG. 6B illustrates the structure of an ARP response packet transmitted from the switching router to the source host of FIG. 5;

FIG. 6C illustrates the structure of an ARP request packet transmitted from the switching router to a destination host of FIG. 5;

FIG. 6D illustrates the structure of an ARP response packet transmitted from the destination host to the switching router of FIG. 5;

FIG. 6E illustrates the structure of a unicast packet transmitted from the source host to the switching router of FIG. 5;

FIG. 6F illustrates the structure of a unicast packet transmitted from the switching router to the destination host of FIG. 5; and

FIG. 7 illustrates the packet transmission/reception operation between the switching router and a plurality of VLANs in the same IP subnet.

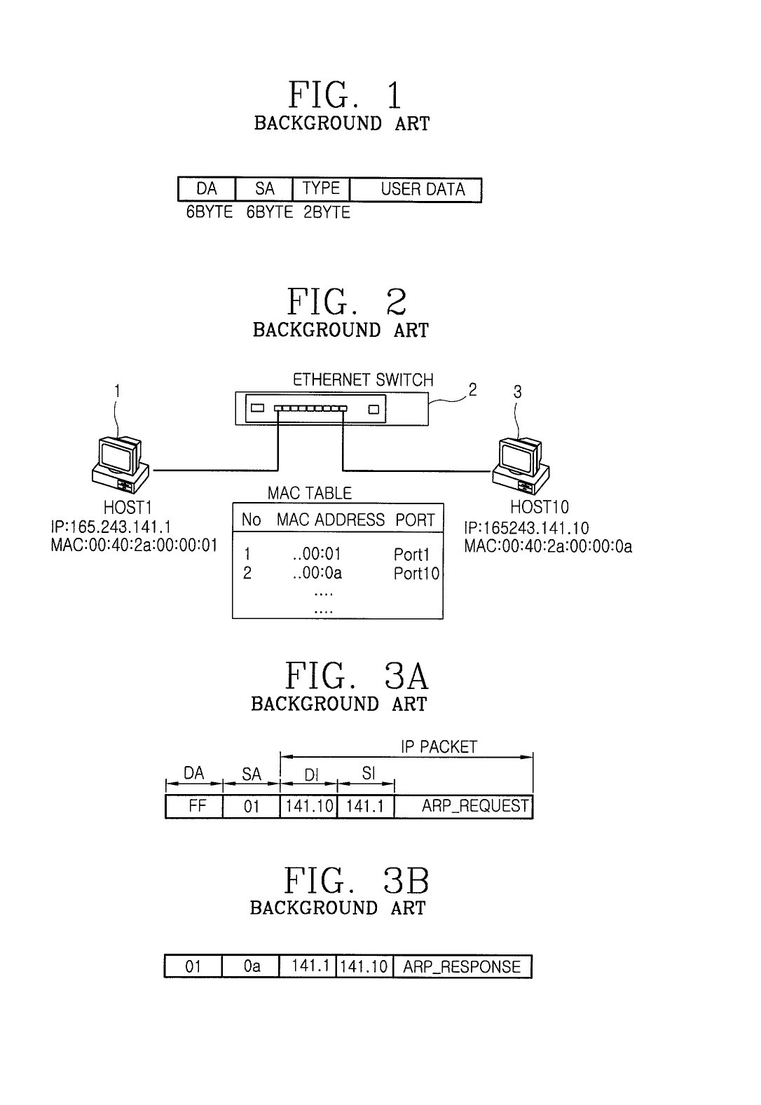

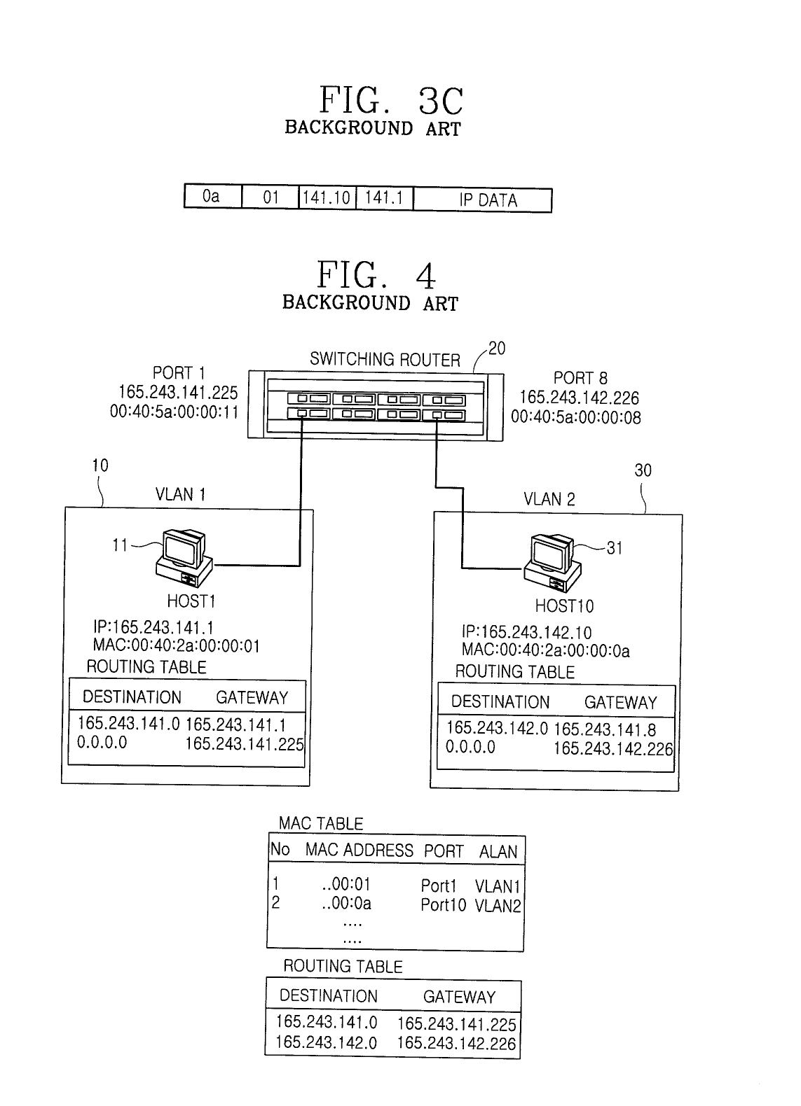

### DETAILED DESCRIPTION OF PREFERRED EMBODIMENTS

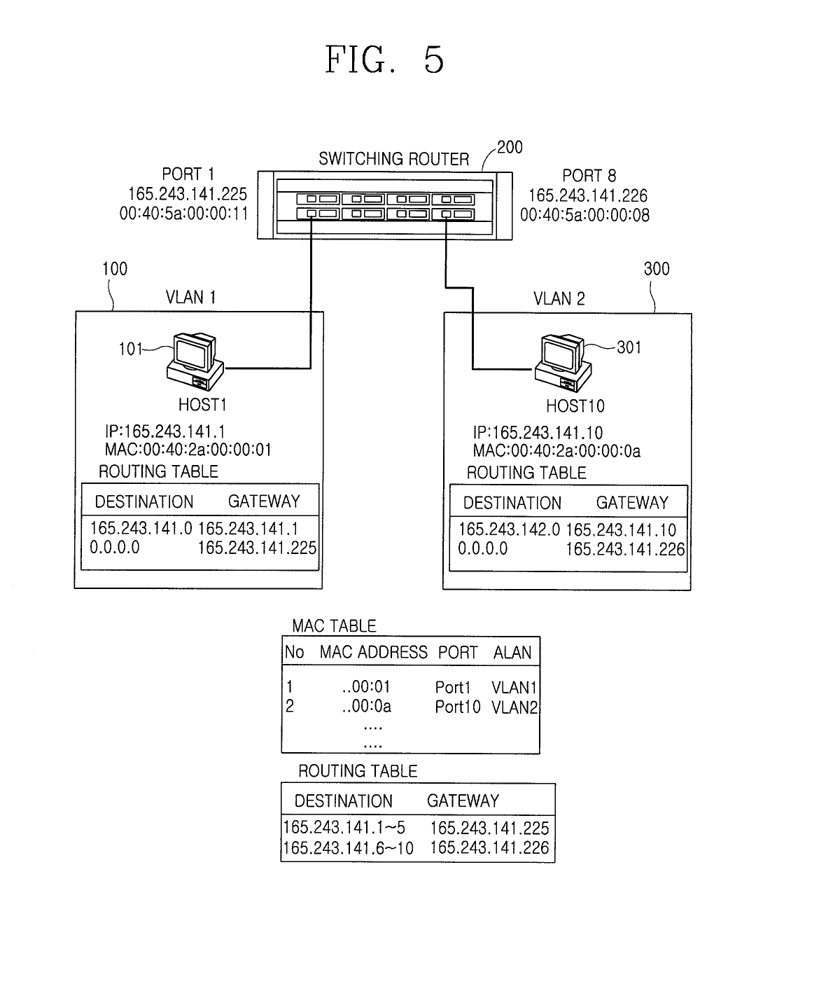

FIG.5 illustrates the connection between a switching router 200 and VLANs 100, 300 in the same IP subnet. First VLAN 100 and second VLAN 300, whose broadcast domains are compulsorily defined, are included in an identical IP subnet. More specifically, first VLAN 100 and second VLAN 300 communicate with each other through a switching router 200, but they are included in the identical IP subnet whose IP address is 165.243.141.xxx. For the convenience of describing this preferred embodiment, assume that the first host 101 included in the first VLAN 100 has an IP address of 165.243.141.1 and a MAC address of 00:40:2a:00:00:01. Also, assume that the tenth host 301 included in the second VLAN 300 has an IP address of 165.243.141.10 and a MAC address of 00:40:2a:00:00:0a. Further assume that each host connected to the LAN already knows the IP addresses of all other hosts, but does not know the MAC addresses of the other hosts. Thus, to communicate with another host, each host must use the ARP to find the MAC address of the host that it intends to communicate with.

For example, suppose the first host 101 intends to communicate with the tenth host 301. The first host 101 is called a source host and the tenth host 301 is called a destination host. If the source host 101 transmits an ARP request packet to the switching router 200 to find the MAC address of the destination host 301, the switching router 200 broadcasts the ARP request packet to the first VLAN 100, to which the source host 101 belongs. Then, the switching router 200 generates an ARP response packet and transmits it to the source host 101. At the same time, the switching router 200 broadcasts the ARP request packet to the second VLAN 300, to which the destination host 301 belongs. The destination host 301, which received the ARP request packet broadcast to the second VLAN 300, transmits an ARP response packet including its own MAC address value to the switching router 200. As a result, the switching router 200 learns the MAC address of the source host 101 and the MAC address of the destination host 301.

Meanwhile, the source host 101, which received the ARP response packet from the switching router 200, transmits a unicast packet to switching router 200. The switching router 200 transmits the received unicast packet to the destination host 301. Communication between a source host in one VLAN and a destination host in another VLAN, of a single IP subnet, is performed by transmitting unicast packets from the source host to the switching router, conveying the unicast packets received on the source port to the destination port, and then transmitting the unicast packets to the destination host through the destination port.

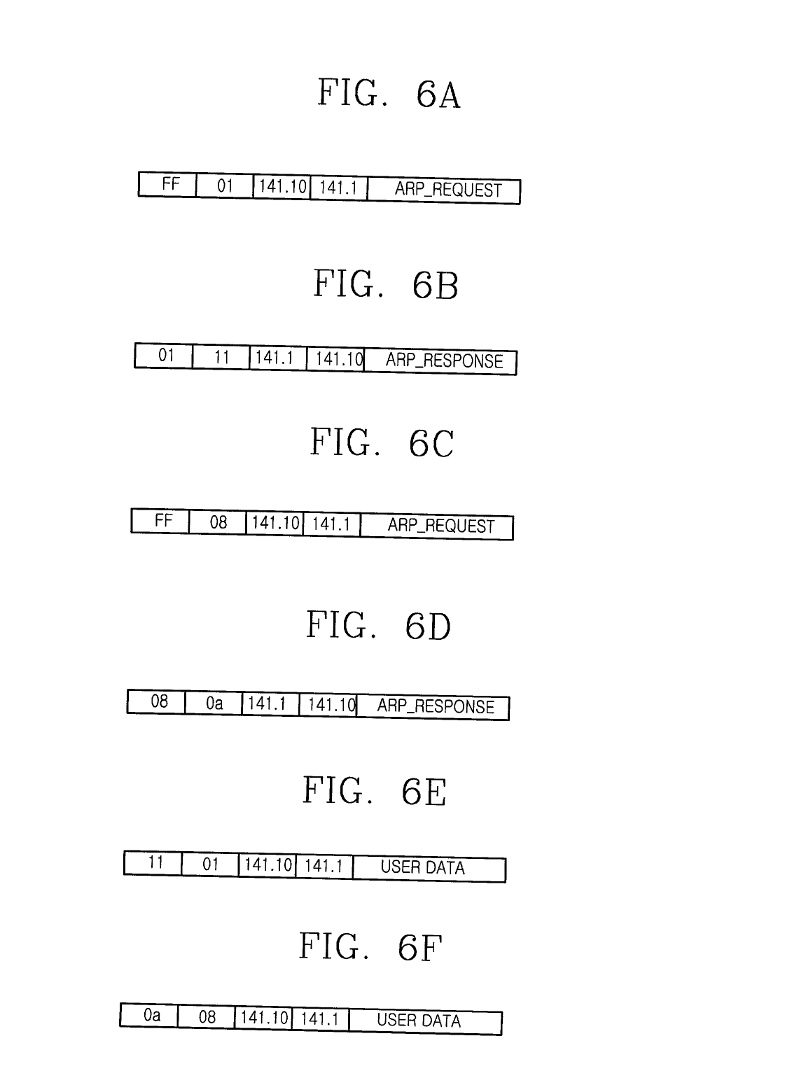

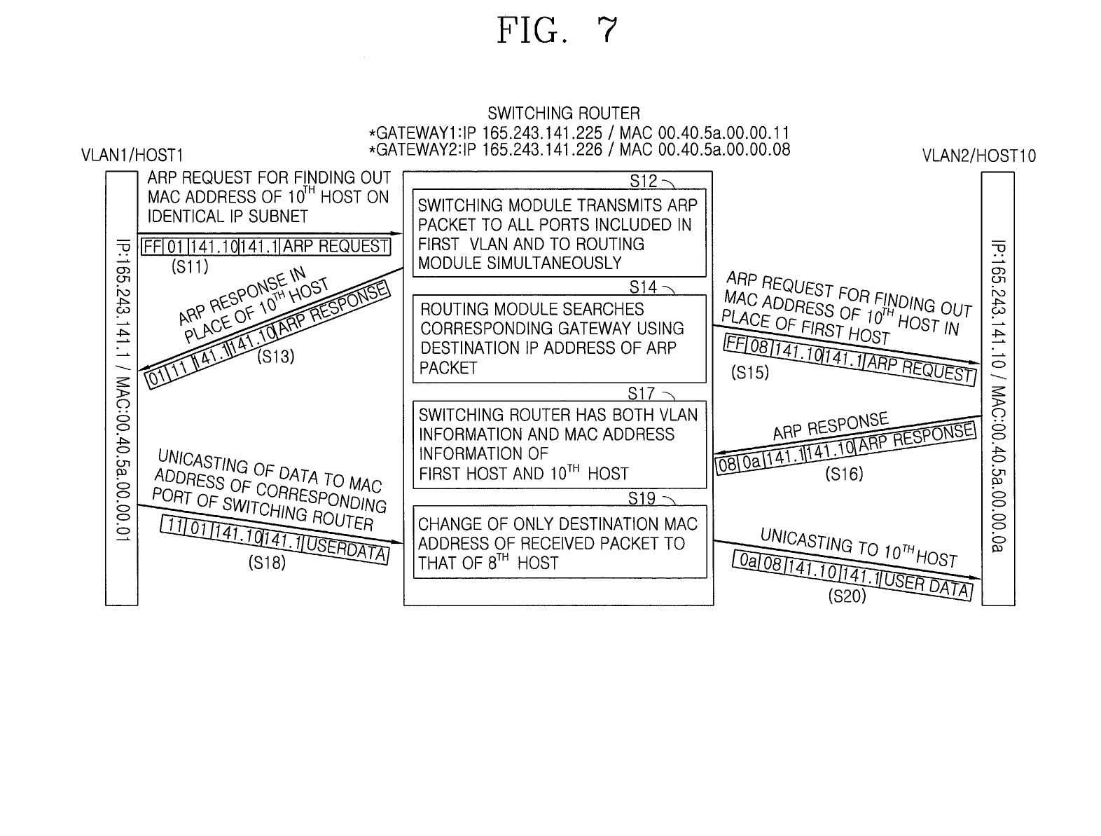

Referring now to FIGS. 5 to 7, the communication method will be explained in greater detail. To find the MAC address of the destination host 301, the source host 101 generates a first ARP request packet, illustrated in FIG. 6A, and transmits the packet to the switching router 200 (step S11). Specifically, the source host 101 generates the first ARP request packet by recording the IP address of the destination host 301 in the DI field, recording its own IP address in the SI field, recording a broadcast address FF in the DA field, and recording its own MAC address in the SA field.

The switching router 200 includes a switching module and a routing module (not illustrated in FIG. 5). The switching module is provided with a MAC table to manage MAC addresses, ports, and mapping relations of the VLANs. Additionally, the switching module performs packet switching in a MAC layer with reference to the MAC table. The routing module is provided with a routing table to manage mapping relations between the IP addresses and gateways and performs packet switching in an IP layer.

The switching module of the switching router 200 receives the first ARP request packet from the source host 101. Using the MAC address of the source host, which it recovers from the SA field of the ARP request packet, and with reference to the MAC table, the switching module identifies all of the ports connecting to VLAN 100, to which the source host 101 belongs. Then, the switching module transmits the first ARP request packet to all of the identified ports and to the routing module, as well (step S12). The switching module registers the MAC address of the source host, the port number, and the VLAN relation of the first ARP request packet in the MAC table.

Then, the switching router 200 generates the ARP response packet, illustrated in FIG. 6B, and transmits the packet to the source host 101 (step S13). The ARP response packet includes a DA field representing the MAC address of the source host 101, an SA field representing the MAC address of the switching router port corresponding to the source host 101, a DI field representing the IP address of the source host 101, and an SI field representing the IP address of the destination host 301.

The routing module of the switching router 200 finds the corresponding gateway (i.e., the corresponding port of the switching router 200) of the destination host from the routing table, using the IP address of the destination host 301 recorded in the DI field of the first ARP request packet (step S14). The switching router 200 broadcasts the second ARP request packet, illustrated in FIG. 6C, to the VLAN that connects to the identified port of the corresponding gateway (step S15). The second ARP request packet generated by the switching router 200 includes a DA field representing the broadcast MAC address, an SA field representing the MAC address of the corresponding gateway, a DI field representing the IP address of the destination host 301, and an SI field representing the IP address of the source host 101.

The destination host 301 receives the second ARP request packet and checks whether it is the intended recipient. If so, the destination host 301 generates the ARP response packet, illustrated in FIG. 6D, by recording its own MAC address in the SA field, recording the MAC address of the switching router port 200 that transmitted the second ARP request packet in the DA field, recording the IP address of the source host in the DI field, and recording its own IP address in the SI field. Then, the destination host 301 transmits the ARP response packet to the switching router 200 (step S16).

The switching router 200 registers the MAC address of the destination host 301, the VLAN corresponding to the destination host 301, and the gateway (i.e., port) to which the destination host is connected in the MAC table, using the information contained in the ARP response packet received from the destination host 301. Thus, the switching router 200 can recognize the MAC address of the source host 101 the MAC addresses of the VLANs corresponding to the source host 101, the MAC address of the destination host 301, and the MAC address of the VLAN corresponding to the destination host 301 (step S17).

Meanwhile, the source host 101 receives the ARP response packet transmitted from the switching router 200, in step S13. The source host 101 interprets the MAC address of the corresponding port (i.e., the port connected to the source host 101) of the switching router 200, recorded in the SA field of the ARP response packet, to be the MAC address of the destination host 301.

Thus, the source host 101 generates the unicast packet, illustrated in FIG. 6E, by recording the MAC address of the corresponding switching router port in the DA field, its own MAC address in the SA field, the IP address of the destination host 301 in the DI field, and its own IP address in the SI field. Then, the source host 101 transmits the generated unicast packet to the switching router 200 (step S18).

The switching router 200 identifies the actual MAC address of the destination host 301 by cross referencing the destination host IP address, culled from the unicast packet, with the real MAC address of the destination host 301 stored in the MAC table. The switching router 200 generates the unicast packet to be conveyed to the destination host 301, as illustrated in FIG. 6F, by recording the MAC address of the destination host 301 in the DA field and recording the MAC address of the switching router port connected to the destination host 301 in the SA field (step S19). The switching router 200 transmits the generated unicast packet to the destination host 301 (step S20).

As described above, the switching router configures a plurality of VLANs in one IP subnet and performs active MAC switching and IP routing among the VLANs. Accordingly, the source and destination hosts, which exist in different VLANs, recognize the switching router as their object host and, thus, the communication between the different VLANs can be performed.

As described above, if the switching router receives a broadcast packet from the source host, it transmits the broadcast packet to all of the VLANs to which the source host belongs, and to the VLAN to which the destination host belongs, as well. Accordingly, the broadcast domain can be formed through a plurality of VLANs on one IP subnet.

Also, a source host, which belongs to a different VLAN than the destination host, transmits its unicast packets to the switching router and the switching router relays the unicast packet to the designation host. Therefore, communication among a plurality of VLANs included in the same IP subnet is enabled.

Furthermore, since a plurality of VLANs are implemented in the same IP subnet, the number of broadcast packets in a small-scale LAN is reduced, thereby reducing the ethernet traffic.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A communication method among a plurality of virtual local area networks (VLANs), each VLAN having a number of hosts, comprising:
broadcasting a first address resolution protocol (ARP) request packet transmitted from a source host of the number of hosts to a source VLAN of the plurality of VLANs;
transmitting a first ARP response packet, responding to the first ARP request packet, to the source host and broadcasting a second ARP request packet to a destination VLAN of the plurality of VLANs in which a destination host addressed by the first ARP request packet is included; and
receiving a second ARP response packet from the destination host and transmitting a unicast packet originating from the source host to the destination host using a media access control (MAC) address of the destination host that is included in the received second ARP response packet.

2. The communication method of claim 1, wherein the plurality of VLANs belong to the same Internet Protocol (IP) subnet, and the method further comprises configuring the plurality of VLANs by configuring a MAC table and a routing table so that the plurality of VLANs are allocated to the same IP subnet, a plurality of ports of a switching router are allocated to the plurality of VLANs, and the respective number of hosts included in each of the plurality of VLANs are mapped to the corresponding allocated plurality of ports.

3. The communication method of claim 1, wherein broadcasting the first ARP request packet to the VLAN in which the source host is included, further comprises:
identifying the source VLAN, based on a MAC source address included in the first ARP request packet; and
broadcasting the first ARP request packet to a number of source ports of a switching router, which are allocated to the source VLAN.

4. The communication method of claim 3, wherein the number of source ports is variably determined in accordance with the number of hosts connected to one VLAN of the plurality of VLANs.

5. The communication method of claim 1, wherein broadcasting the second ARP request packet further comprises:
generating the first ARP response packet in response to the first ARP request packet;
transmitting the generated first ARP response packet to the source host;
generating the second ARP request packet for finding out the MAC address of the destination host identified by the first ARP request packet;
identifying the destination VLAN in which the destination host is included; and
broadcasting the second ARP request packet to all destination ports of a plurality of switching router ports allocated to the destination VLAN.

6. The communication method of claim 1, wherein the first ARP response packet comprises a destination address (DA) field representing the MAC address of the source host, a source address (SA) field representing the MAC address of a source port, of a switching router, mapped on the source host, a destination IP address (DI) field representing an IP address of the source host, and a source IP address (SI) field representing the IP address of the destination host.

7. The communication method of claim 1, wherein the second ARP request packet comprises a destination address (DA) field representing a broadcast MAC address, a source address (SA) field representing the MAC address of a source port, of a switching router, mapped on the destination host, a destination IP address (DI) field representing an IP address of the destination host, and a source IP address (SI) field representing the IP address of the source host.

8. The communication method of claim 5, wherein identifying the destination VLAN in which the destination host is included further comprises:
reading an IP address of the destination host from the first ARP request packet;
identifying a source port, of a switching router, mapped on the IP address of the destination host; and
identifying the source port allocated to the source VLAN.

9. The communication method of claim 1, wherein transmitting the unicast packet to the destination host further comprises:
receiving the second ARP response packet from the destination host;
storing the MAC address of the destination host included in the received second ARP response packet;
receiving a first unicast packet from the source host; and
generating a second unicast packet based on the first unicast packet and transmitting the second unicast packet to the destination host.

10. The communication method of claim 9, wherein the second ARP response packet comprises a source address (SA) field representing the MAC address of the destination host, a destination address (DA) field representing the MAC address of a port of a switching router that broadcast the second ARP request packet, a destination IP address (DI) field representing an IP address of the source host, and a source IP address (SI) field representing the IP address of the destination host.

11. The communication method of claim 1, wherein the unicast packet comprises a destination address (DA) field representing the MAC address of a port of a switching router that transmitted the first ARP response packet, a source address (SA) field representing the MAC address of the source host, a destination IP address (DI) field representing an IP address of the destination host, and a source IP address (SI) field representing the IP address of the source host.

12. The communication method of claim 9, wherein the second unicast packet comprises a destination address (DA) field representing the MAC address of the destination host, a source address (SA) field representing the MAC address of a corresponding port of a switching router connected to the destination host, a destination IP address (DI) field representing an IP address of the destination host, and a source IP address (SI) field representing the IP address of the source host.

13. A broadcast domain determining method for communications among a plurality of virtual local area network (VLANs) in the same Internet protocol (IP) subnet, comprising:
identifying a second VLAN of the plurality of VLANs which is included in the same IP subnet as a first VLAN containing a source host, if an address resolution protocol (ARP) request packet is received from the source host;
identifying all second VLAN ports of a number of ports connected to the second VLAN;
broadcasting the ARP request packet to all of the second VLAN ports;
identifying a destination port of the second VLAN ports in which a destination host of the ARP request packet is included; and
broadcasting the ARP request packet to the second VLAN connected to the destination port.

14. The method of claim 13, wherein identifying the destination port includes identifying the destination port based on an IP address of the destination host, which is represented in a destination IP address (DI) field of the ARP request packet.

15. A communication method among a plurality of virtual local area networks (VLANs) in the same Internet protocol (IP) subnet, comprising:
broadcasting an address resolution protocol (ARP) request packet to communicate with a destination host that belongs to the same IP subnet as a source host, but belongs to a different VLAN of the plurality of VLANs than the source host;
informing the source host of a media access control (MAC) address of a switching router, using a communication from the switching router provided in response to the ARP request packet;
obtaining the MAC address of the destination host by broadcasting the ARP request packet from the switching router to a second VLAN of the plurality of VLANs, in which the destination host is included;
transmitting to the switching router a first data packet to be transmitted to the destination host by the source host, via the switching router; and
transmitting the received first data packet from the switching router to the destination host using the MAC address of the destination host.

16. The communication method of claim 15, further comprising:
transmitting to the switching router a second data packet to be transmitted to the source host from the destination host, via the switching router; and
transmitting the second data packet from the switching router to the source host using the MAC address of the source host.

17. The communication method of claim 15, wherein the source host knows the MAC address of a corresponding port of the switching router to which the source host is connected, but does not know the MAC address of the destination host.

18. The communication method of claim 15, wherein the destination host knows the MAC address of a corresponding port of the switching router to which the destination host is connected, but does not know the MAC address of the source host.

19. A communication method among a plurality of networks in a subnet, comprising:
communicating a first message from a source host, within a first network of the plurality of networks, to a destination host, within a second network of the plurality of networks, by addressing the first message to a first intermediate address of an intermediary device, which supports communication among the plurality of networks;
receiving the first message with the intermediary device;
associating a destination proxy address, of the destination host, contained in the first message with a destination address of the destination host; and
communicating the first message from the intermediary device to the destination host by addressing the first message to the destination address.

20. The communication method of claim 19, further comprising:
communicating a second message from the destination host to the source host by addressing the second message to a second intermediate address of the intermediary device;
receiving the second message with the intermediary device;
associating a source proxy address, of the source host, contained in the second message with a source address of the source host; and
communicating the second message from the intermediary device to the source host by addressing the second message to the source address.

21. The communication method of claim 19, wherein the source host determines the first intermediate address using a method comprising:
associating, within the intermediary device, the destination proxy address with the first intermediate address;
broadcasting a first address resolution packet (ARP) request containing the destination proxy address and a global destination address from the source host to a number of first hosts sharing a first network, of the plurality of networks, with the source host;
responding to the first ARP request by sending a first ARP response from the intermediary device to the source host containing the first intermediate address, wherein
the intermediary device responds to the first ARP request due to the association between the destination proxy address, included within the first ARP request, and the first intermediate address.

22. The communication method of claim 21, wherein the intermediary device determines the destination address using a method comprising:
broadcasting a second address resolution packet (ARP) request containing the destination proxy address and the global destination address from the intermediary device to a number of second hosts sharing a second network, of the plurality of networks, with the destination host;
responding to the second ARP request by sending a second ARP response from the destination host to the intermediary device containing the destination address, wherein
the destination host responds to the second ARP request because the ARP request contains the destination proxy address.

23. The communication method of claim 21, wherein:
the plurality of networks include multiple virtual local area networks;
the subnet is an Internet Protocol (IP) subnet;
the first ARP request comprises a destination address field identifying a media access control (MAC) address of the global destination address, a source address field identifying the MAC address of the source host, a destination IP address field identifying an IP address of the destination host, and a source IP field identifying the IP address of the source host.

24. The communication method of claim 21, wherein:
the plurality of networks include multiple virtual local area networks;
the subnet is an Internet Protocol (IP) subnet;
the first ARP response comprises a destination address field identifying a media access control (MAC) address of the source host, a source address field identifying the MAC address of the intermediary device's first intermediate address, a destination IP address field identifying an IP address of the source host, and a source IP field identifying the IP address of the destination host.

25. The communication method of claim 22, wherein:
the plurality of networks include multiple virtual local area networks;
the subnet is an Internet Protocol (IP) subnet;
the second ARP request comprises a destination address field identifying a media access control (MAC) address of the global destination address, a source address field identifying the MAC address of the intermediary device's second intermediate address, a destination IP address field identifying an IP address of the destination host, and a source IP field identifying the IP address of the source host.

26. The communication method of claim 22, wherein:
the plurality of networks include multiple virtual local area networks;
the subnet is an Internet Protocol (IP) subnet;
the second ARP response comprises a destination address field identifying a media access control (MAC) address of the intermediary device's second intermediate address, a source address field identifying the MAC address of the destination host, a destination IP address field identifying an IP address of the source host, and a source IP field identifying the IP address of the destination host.

27. The communication method of claim 19, wherein:
the plurality of networks include multiple virtual local area networks;
the subnet is an Internet Protocol (IP) subnet;
the first message comprises a destination address field identifying a media access control (MAC) address of the intermediary device's first intermediate address, a source address field identifying the (MAC) address of the source host, a destination IP address field identifying an IP address of the destination host, and a source IP field identifying the IP address of the source host.

28. An improved communication system having a plurality of networks interconnected within a subnet by a switching router, wherein each network has a number of hosts, the improvement comprising:
a first address resolution means for providing a media access control (MAC) address of a first host, within a first network, to the switching router;
a second address resolution means for providing the first host with the MAC address of a first port that interconnects the switching router to the first network;
a third address resolution means for providing a second host with the MAC address of a second port that interconnects the switching router to the second network;
a fourth address resolution means for providing the switching router with the MAC address of the second host, wherein
the second, third, and fourth address resolution means operate in response to an operation of the first address resolution means, and
the first address resolution means is operated when the first host has a message to convey to the second host but the first host has neither the second hosts's MAC address nor a MAC address of the switching router, which operates as a proxy for the second host's MAC address.
